(19) United States
(12) Patent Application Publication
(10) Pub. No.: US 2016/0364666 A1
(43) Pub. Date: Dec. 15, 2016

(54) DYNAMICALLY CONTROLLING INDUSTRIAL SYSTEM OUTAGE ASSIGNMENTS TO ACHIEVE DOSE STATES

(71) Applicant: General Electric Company, Schenectady, NY (US)

(72) Inventors: Christopher Donald Johnson, Niskayuna, NY (US); Ilkin Onur Dulgeroglu, Niskayuna, NY (US); David Joseph Brewer, Wilmington, NC (US); Gregg Allen Schneider, Wilmington, NC (US); Eric Russell Mino, Wilmington, NC (US); Sean Fuller, Wilmington, NC (US); Hao Dinh, San Ramon, CA (US); Scott Hamrick, San Ramon, CA (US)

(21) Appl. No.: 14/839,449

(22) Filed: Aug. 28, 2015

Related U.S. Application Data
(60) Provisional application No. 62/175,002, filed on Jun. 12, 2015.

(51) Int. Cl. G06Q 10/06; G06Q 50/06

(52) U.S. Cl. CPC G06Q 10/06312; G06Q 50/06

(57) ABSTRACT

A method of dynamically adjusting an industrial system outage plan is disclosed. Data items pertaining to changes to past plans associated with past outages of a plurality of industrial systems are received along with optional inputs from physics based model(s) of the system, such as a fuel model. The data items include measurements of impacts of changes to the past plans. Work rules pertaining to a work force are received. The work force is responsible for implementing an additional plan corresponding to an additional outage of an additional industrial system. The work rules include fatigue thresholds for workers in the work force. Based on a determination that a probability that one or more fatigue thresholds will be exceeded, a recommendation for a change to the additional plan is generated. The recommendation is based on the measurements of the impacts of the changes to the past plans.

### CROSS-REFERENCE TO RELATED APPLICATIONS

This application claims the benefit of U.S. Provisional Application No. 62/175,002, filed Jun. 12, 2015, which is herein incorporated by reference in its entirety.

### TECHNICAL FIELD

The present application relates generally to the technical field of managing industrial systems, and, in one specific example, to dynamically controlling worker assignments, certain workscopes, such as fuel type, concentration, amounts, placements, and project tasks in the planning and execution of one or more industrial system outage(s) to achieve a dynamically assigned limit such as neutron doses, chemical compound or other limit by person or in aggregate for persons or industrial systems for a future period.

### BACKGROUND

Industrial systems or facilities include systems that generate electric power, such as a generating station, power plant, powerhouse, or generating plant. Such industrial systems may consume nuclear or burn fossil fuels to generate electricity or may use cleaner renewable sources, such as solar, wind, wave, or hydroelectric sources. Industrial systems typically undergo periods of scheduled (or unscheduled) outages or shutdowns for maintenance purposes. For example, a nuclear power plant having one reactor may power down every 12 or 18 months (e.g., during low-demand periods in the spring or autumn). During the outage, hundreds to thousands of workers may be assigned to project tasks associated with a project or plan for the outage. Tasks may include replacing fuel in the reactor, performing inspections, replacing equipment, or performing other maintenance tasks. Various requirements, such as government regulatory requirements pertaining to safety, may constrain the assignment of various workers to particular project tasks and tasks to various industrial systems.

### BRIEF DESCRIPTION OF THE DRAWINGS

Some embodiments are illustrated by way of example and not limitation in the figures of the accompanying drawings.

FIG. 1 is a network diagram depicting a client-server system within which various example embodiments may be deployed.

FIG. 2 is a block diagram illustrating multiple server applications that, in various example embodiments, are provided as part of the networked system of FIG. 1.

FIG. 3 is a block diagram illustrating an example method 300 of implementing decision making during an outage or exercise plan associated with an industrial system.

FIG. 4 is a flowchart illustrating example operations of a method for optimizing a plan for managing an outage at an industrial system.

FIG. 5 is a flowchart illustrating example operations of a method for selecting an optimal course of action to improve the chances that a project will be completed on time or on budget or to mitigate the consequences of a time or budget overrun.

FIG. 6 is a flowchart illustrating example operations of a method for modifying a plan for an outage in real time based on collective intelligence gathered from previous outages.

FIG. 7 is a flowchart illustrating example operations of a method for generating a real-time dynamic report identifying the impact of modifications to an outage plan on various success metrics.

FIGS. 8AA-8AC are a first portion of an example user interface for aiding a stakeholder in making a decision during an actual outage with regard to a modification to a plan for the outage.

FIG. 8B is a second portion of the example user interface for aiding the stakeholder in making the decision during an actual outage with regard to a modification to a plan for the outage.

FIG. 9 is an example user interface 900 of a dynamic report that is generated and updated during the execution of a project plan.

FIG. 10 is a block diagram of machine in the example form of a computer system within which instructions for causing the machine to perform any one or more of the methodologies discussed herein may be executed.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

An important objective during an industrial system outage is to complete a set of tasks associated with a plan for the outage given the constraints of exposure to elements, including heat, radiation, or chemicals, while maximizing the probability of remaining on time and on budget is disclosed. Thus, an automated control system for managing an industrial system outage may be designed to control tasks, work scope and resources that may cause the schedule or exposure or financial risk to exceed the desired state as desired by one or more stakeholders associated with the plan and dynamic outage execution over one or more outage events, including decomissioning.

Data items pertaining to actual implementations of multiple plans or projects associated with multiple outages at multiple industrial systems may be collected over a time period. The data items may be used to generate a probability that a particular task may be completed within a particular budget and within a particular period of time. Additionally, the data items may be used to generate probabilistic distributions of the success rate of each the various tasks with respect to various metrics, including budget and time metrics. Thus, for example, from a collection of data items pertaining to actual projects implemented during hundreds of outages over a time period (e.g., of 30 years), the decision-support system may identify with a particular percentage of certainty that a particular maintenance task (e.g., an inspection of a particular piece of equipment, a replacement of a part, and so on) will be completed within a certain time period and consume a certain labor and material concentration.

Based on an aggregation of probability data associated with each individual task in a project associated with an additional outage at an additional industrial system, the probability that the project will be completed on time and on budget may be monitored in real time. When the chances that the project will be completed on time or on budget fall below a predetermined threshold, such as a predetermined threshold agreed upon by stakeholders associated with the project, the dynamically optimal control system identifies a set of tasks that are the most significant causes of the chances falling below the threshold. Additionally, the dynamically optimal control system may generate a set of what-if scenarios, including removing tasks from the project, changing work scope such as fuel amounts, types and placements, reassigning workers, hiring additional workers, and so on, that may bring the probability that the project will be completed on the desired time back above the threshold value. In the instance of multiple outages over time, tasks and work scope may be optimally moved to achieve a specified state at one or more points in time. In an example embodiment use for a nuclear power plant which is being operated, maintained and then decommissioned, a derived assignment is enabled with the disclosed system, for example, certain fuel is placed in certain locations in the reactor over one or more outages so as to achieve a power output and a decommissioning cost state. Given this optimal plan, during any given outage, should certain workscope be delayed due to worker exposure or tasks that are proceeding too slowly, the overall multiperiod plan is dynamically optimized to meet the critical needs of refueling enough of the reactor for the next operating period and postponing reserve fuel or changing fuel types in a subsequent outage. Resources are dynamically assigned, tasks are added and dropped for both the current outage probabilities and the multiperiod objectives of cost and radiation level.

The what-if scenarios may be based on simulations analyzed with respect to data items associated with the current outage and data items collected during previous outages. The what-if scenarios may include generation of a cost-benefit analysis, including an analysis of the effect of adding a task to or removing a task from the set of tasks associated with a project, delaying the completion of the project (e.g., extending the outage), or hiring additional workers to complete the project. The analysis may include predictions of the impact of choosing a particular option to address delays or cost overruns in the project or sequencing of outages, including an impact on a performance metric of the industrial system, such as an impact on the net present value of the industrial system, a future financial statement of the industrial system, an efficiency measure of the industrial system, and so on. Stakeholders associated with the project may then be presented with visualizations pertaining to the cost-benefit analysis in order to make an informed decision, in real time, of how best to adjust the project plan before, during or after a given outage. In various embodiments, the dynamically optimal control system may recommend one or more courses of action. Thus, acceptance of a particular course of action may be based on a combination of the recommended courses of action and input from the stakeholders.

In various embodiments related to the dynamical control of physical or financial states within a current outage, dynamically managing a crew or work force assigned to the project tasks based on the impact of a priori unforeseen circumstances, such as radiation exposure, is an important aspect to keeping a project on track. For example the tasks related to a key work scope are delayed because a person with an essential skill receives too much dose and must leave the task, however there is no replacement worker and thus delay occurs with a stoppage and a wait on qualified replacement labor to be found, assessed for available dose capability and ramp up into the task. In various embodiments, each member of the work force may be monitored for compliance with various regulations (e.g., government safety regulations or company regulations). In various embodiments, each worker may be provided with one or more tracking devices. An example of such a tracking device may be referred to as a roentgen equivalent man (rem) bit or Rembit. The Rembit device may track data pertaining to a worker's location, activity and biofeedback (fatigue), and radiation exposure. Such data may include an activity level of the worker at a particular location, time periods in which a worker has been engaged in particular tasks, and doses of radiation that the user has been exposed to or absorbed.

Data items collected from the tracking devices associated with each worker may be fed into the probabilistic model of the project plan in real-time. Thus, an amount to which workers are exposed to or absorb radiation, or the amount of fatigue that workers have suffered, may affect a probability that a particular task will be completed on time and an budget which the system calculates and controls. Additionally, the data items collected from the tracking devices may require unforeseen reassignments of workers to different tasks or requirements for work crews to change out ahead of schedule. In various embodiments, the real-time worker tracking data may be presented as a visualization to the stakeholders of the project such that they may proactively address any required work force changes. For example, stakeholders may be presented with a visualization showing an estimation of when radiation levels for a particular work force assigned to a particular project task are likely to exceed threshold values during the actual outage in comparison to the initial estimation incorporated into the project plan, and what the dosage states of candidate replacement labor is so that an automated optimal reassignment is made by the control system.

In various embodiments, data items pertaining to changes to past plans associated with past outages of a plurality of industrial systems are received. The data items include measurements of impacts of changes to the past plans. Work rules pertaining to a work force are received. The work force is responsible for implementing an additional plan corresponding to an additional outage of an additional industrial system. The work rules include fatigue thresholds for workers in the work force. Based on a determination during the outage of a probability that one or more fatigue thresholds will be exceeded, a recommendation for a change to the additional plan is generated. The recommendation is based on the measurements of the impacts of the changes to the past plans and the dynamic states of current workers through time. The additional plan is modified based on an acceptance of the recommendation by a plurality of stakeholders associated with the additional plan.

Thus, in various embodiments, worker assignments and project tasks are dynamically controlled in the planning and execution of one or more industrial system outage(s) to achieve a dynamically assigned limit such as neutron doses, chemical compound or other limit by person or in aggregate for persons or industrial systems for a future period up to and including decomissioning. A beneficial adjacent advantage is to mitigate an increased probability that a plan for the one or more industrial system outage(s) will be optimized so as to not exceed constraints (e.g., personnel dose, net dose of the industrial system, budget or time) associated with the plan and its dynamical execution through time.

For example, in various embodiments, the dose of humans who are working on tasks during one or more outages is dynamically controlled by the system to not exceed a certain cumulative state in the instant or through time. Furthermore, despite a robustly optimized outage plan, unforeseen events or circumstances may require reassignment of workers to different tasks during an outage. Thus, being able to efficiently monitor and manage the work force with respect to tasks during an outage as well as dynamically adjust the task and assignment plans for the one or more outages is an important aspect to ensuring that the plan is completed on time and on budget, subject to constraints at a desired probability.

In various embodiments, work scope and tasks are managed through one or more outages to achieve a physical and financial state such as a neutron intensity and economic surplus, through time.

In various embodiments, the probabilities of the desired physical or economic states are automatically controlled by scope and resource (such as persons) assignment to exposures. In both embodiments, an apriori optimal plan is calculated for one or more outages and during those outages, the tasks and resource assignments are dynamically controlled to achieve the prescribed physical and economic states. Tasks may be automatically moved in a dynamic plan across multiple outages in the plan and during a given outage to another outage.

In various embodiments, one or more modules are incorporated into a networked system to perform the one or more of the various operations described herein, the one or more modules being implemented by one or more processors of the networked system.

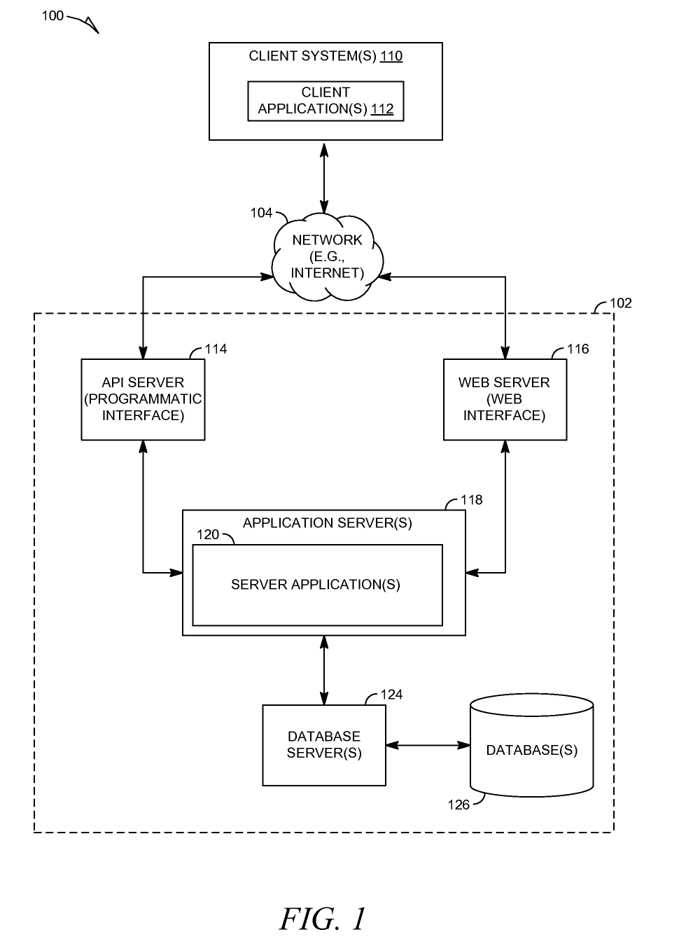

FIG. 1 is a network diagram depicting a system 100 within which various example embodiments may be deployed. A networked system 102, in the example form of a decision-support system, provides server-side functionality, via a network 104 (e.g., the Internet or Wide Area Network (WAN)) to one or more clients machines 110. FIG. 1 illustrates client application(s) 112 on the client machines 110. Examples of client application(s) 112 may include a web browser application, such as the Internet Explorer browser developed by Microsoft Corporation of Redmond, Wash. or other application supported by an operating system of the device, such as Windows, iOS or Android operating systems. Each of the client application(s) 112 may include a software application module (e.g., a plug-in, add-in, or macro) that adds a specific service or feature to a larger system.

An API server 114 and a web server 116 are coupled to, and provide programmatic and web interfaces respectively to, one or more application servers 118. The application servers 118 host one or more server application(s) 120. The application servers 118 are, in turn, shown to be coupled to one or more database servers 124 that facilitate access to one or more databases 126 or data stores, such as NoSQL or non-relational data stores.

The applications 120 may provide a number of functions and services to users that access the networked system 102. While the applications 120 are shown in FIG. 1 to form part of the networked system 102, in alternative embodiments, the various applications 120 may form part of a service that is separate and distinct from the networked system 102.

Further, while the system 100 shown in FIG. 1 employs a client-server architecture, various embodiments are, of course, not limited to such an architecture, and could equally well find application in a distributed, or peer-to-peer, architecture system, for example. The various server applications 120 could also be implemented as standalone software programs, which do not necessarily have networking capabilities. Additionally, although FIG. 1 depicts machines 110 as being coupled to a single networked system 102, it will be readily apparent to one skilled in the art that client machines 110, as well as client applications 112, may be coupled to multiple networked systems, such as networked systems associated with one or more industrial systems.

Web applications executing on the client machine(s) 110 may access the various applications 120 via the web interface supported by the web server 116. Similarly, native applications executing on the client machine(s) 110 may accesses the various services and functions provided by the applications 120 via the programmatic interface provided by the API server 114. For example, the third-party applications may, utilizing information retrieved from the networked system 102, support one or more features or functions on a website hosted by the third party.

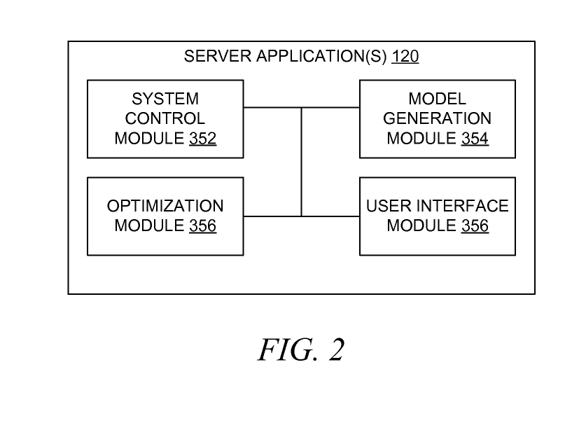

FIG. 2 is a block diagram illustrating multiple server applications 120 that, in various example embodiments, are provided as part of the networked system 102. The server applications 120 may be hosted on dedicated or shared server machines (not shown) that are communicatively coupled to enable communications between server machines. The server applications 120 themselves are communicatively coupled (e.g., via appropriate interfaces) to each other and to various data sources, so as to allow information to be passed between the server applications 120 so as to allow the server applications 120 to share and access common data. The server applications 120 may furthermore access one or more databases 126 via the database servers 124.

A system control module 352 may be configured to receive inputs and generate outputs via one or more user interfaces, as described in more detail below. A model generation module 354 may be configured to, based on the inputs, generate models for use in one or more simulations, as described in more detail below. An optimization module 356 may be configured to use the generated models to repeatedly simulate an outage at an industrial system based on one or more inputs, revising the inputs over time to determine optimal inputs for an industrial system outage plan, as described in more detail below. A user interface module 356 may be configured to generate one or more user interfaces to, for example, receive data or transmit data, as described in more detail below.

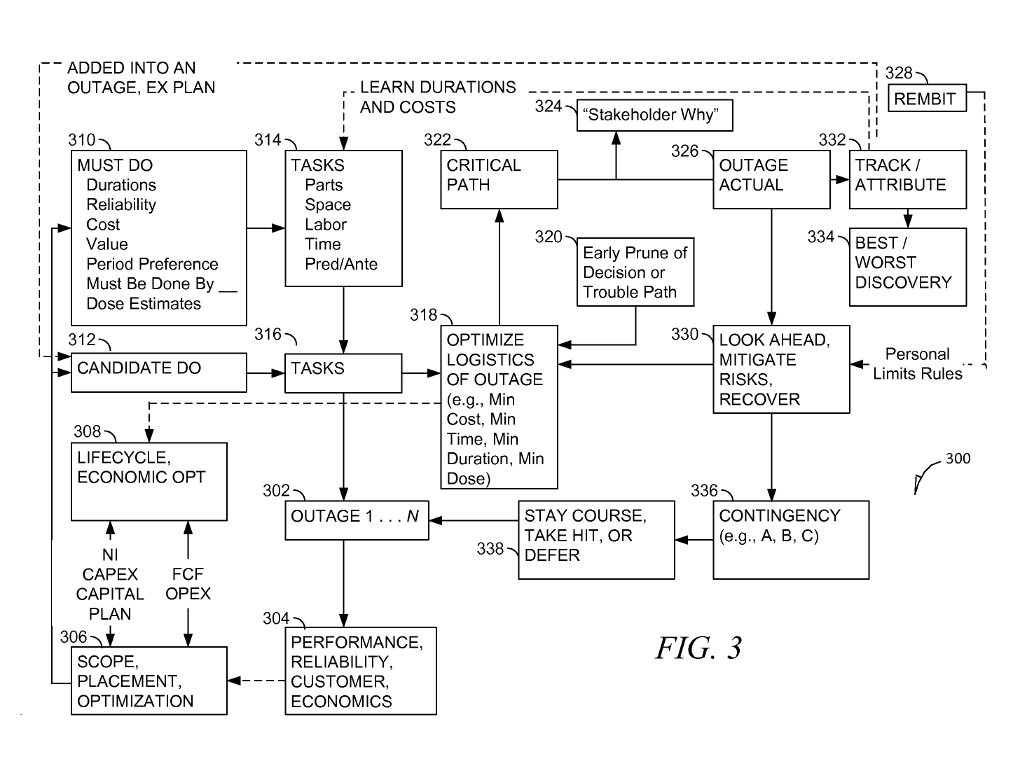

FIG. 3 is a block diagram illustrating an example method 300 of implementing decision making during an outage or exercise plan associated with an industrial system. In various embodiments, the operations of method 300 may be implemented by one or more of the server applications 120. At operation 302, one or more outages for the industrial system are defined for the calculations required to achieve one or more physical or financial states. In various embodiments, the start and end dates of each of the one or more outages are selected based on various criteria, such as supply and demand levels for an output (e.g., electricity, the cumulative radiation or the net financial position) of the industrial system. For example, one or more outages for a nuclear reactor may be scheduled every 12 or 18 months based on a low-point of demand for electricity generated by the nuclear reactor or a prediction of a low-point in profits generated by the reactor for stakeholders managing the operation of the reactor or a sequential loading of certain fuels in one or more outages to achieve a lifecycle of operations and decommissioning financial result.

At operation 304, a risk-return analysis is performed. In various embodiments, the start date and length of the outage may be based on a risk-return analysis. The risk-return analysis may include one or more of an analysis of gains in performance that are to be achieved by the tasks performed during the outage, losses in performance that would be suffered if tasks are not performed during the outage, a measurement to an impact to the customer of the outage (e.g., increased rates, lack of service, and so on), and an assessment of the economics surrounding the outage (e.g., a measurement of the outage on supply and demand or lifecycle radiation or financial state).

At operation 306, an initial scope of a given outage is determined. For example, an initial set of tasks is selected for performance during the outage. For example, the initial set of tasks may include one or maintenance tasks that must be or should be performed during the outage. The initial set of tasks may also include one or more maintenance tasks that should be performed (e.g., to improve an efficiency of the industrial system in the next period and/or to achieve a lifecycle financial result).

At operation 308, economic options and lifecycle data from implementation and optimizations of actual previous outages and operations of other industrial systems are incorporated into the planning of a current outage or multiple outages for the industrial system, as described in more detail below.

At operation 310, a set of must-do tasks is identified from the initial set of tasks. The must-do tasks may include tasks that are required to be performed (e.g., based on requirements of a government regulatory agency or requirements of stakeholders associated with the operation of the industrial system or placement of specified fuel). Additionally, for each must-do task, various attributes are identified, including probabilistic values pertaining to the duration, reliability of completion within the time period of a particular outage, cost, value, period preference, completion date requirements, and worker dose estimates. In various embodiments, the values of the attributes (and the probabilities of the values) of each must-do task are derived from data items collected from multiple other industrial systems during the implementation of plans associated with multiple previous outages. Models other than inference or experienced based task-labor-cost-time may be hosted by the disclosed system, such as a fuel placement and consumption model which, given the operations of the plant, its fuel plan (type, location) and its maintenance work scope over one or more periods, calculates the state of radioactivity and thus the influence upon exposure to persons or in aggregate such as the radiation from a core, through time.

At operation 312, a set of candidate-do tasks is identified from the initial set of tasks. The candidate-do tasks may include tasks that may be optionally performed within the next or other specified time period.

At operation 314, implementation details associated with the must-do tasks are determined. Such implementation details, including assigning parts, space, labor, time, and so on to each task. Additionally, the implementation details may include determining predecessor tasks and antecedent tasks that are to be completed in associated with each must-do task.

At operation 316, implementation details associated with the candidate-do tasks are determined, just as with the implementation details for the must-do tasks.

At operation 318, logistics of the outage are optimized. The optimization process may include running multiple simulations of the outage based on a probabilistic model generated from the data items associated with multiple previous outages of multiple other industrial systems, as described in more detail below. In various embodiments, various estimates of metrics associated with each task planned for inclusion in the outage may be estimated, including a probabilistic distribution of the cost, time, duration, and radiation exposure or absorption (e.g., dose) of each task over predicted minimum and maximum values of each of the metrics.

At operation 320, an early pruning of trouble paths associated with the initial plan may be performed. For example, any candidate-do tasks that fall onto the critical path may be automatically moved from the plan for the current outage to a plan for a subsequent outage.

At operation 322, a critical path for the implementation of the plan for the outage is identified. The critical path may include a listing of tasks having durations that are most likely to affect the overall duration of the plan. In other words, if an unforeseen circumstance increases a duration of one the tasks in the critical path, the overall duration of the plan will increase as well.

Separately, it can be appreciated that a sequence of work scope and tasks managed in a short time frame such as three weeks characterize a given outage and that an economic lifecycle of many decades for example is a sequence of work scope, operations and decommissioning that is a coupled-temporal system with physical and economic states that also are dynamically calculated and controlled for the lifecycle optimization of one or more goals such as finance and radiation level.

At operation 324, information pertaining to the optimization of the logistics is communicated to one or more stakeholders associated with the plan for the outage. The information may include reasons why particular tasks were initially selected for the outage, reasons why particular tasks were identified as must-do or candidate-do tasks for the outage, reasons why particular tasks were identified as being on the critical path, and so on. The reasoning may include presentations of visualizations pertaining to the optimization of the logistics, as described in more detail below.

At operation 326, the actual outage commences. The actual progress of the implementation of the plan for the outage is tracked in real time. In various embodiments, at operation 328, data from one or more tracking devices (e.g., Rembits) is collected from one or more workers assigned to each of the project tasks. At operation 330, personal limits rules (e.g., based on government or stakeholder requirements) are analyzed in conjunction with the data collected from the tracking devices. At operation 330, if the probability that a limit will be exceeded transgressed a threshold value, options for risk mitigation are considered. In various embodiments, the probability thresholds may be predetermined by stakeholders. For example, the stakeholders may determine that if the probability that a personal limit will be exceeded transgressed 20%, then the mitigation process is to commence.

At operation 332, data items pertaining to the implementation of the plan during the actual outage are stored for future reference. For example, the actual costs, profits and durations of the tasks are stored for use in a probabilistic model. The probabilistic model may include an aggregation of actual costs and durations of similar tasks stored by other industrial systems during actual outages. Thus, the estimates of costs and durations may be improved over time and incorporated into subsequence outage plans. At 334, discoveries of the best and worst results (e.g., as judged by stakeholders or an automatic analysis of the probabilistic model for the outage) are captured and stored for later analysis, as described in more detail below.

At operation 336, if the mitigation process 330 identifies that a risk of the actual outage exceeding a budget or duration constraint has exceeded a threshold value, contingency plans may be identified. Additionally any discrepancies between the actual progress and the planned progress are identified. Contingency plans are identified based on their chances of increasing the probability of brining the project back within time and budget constraints. Additionally, contingency plans may be analyzed based on the probability of minimizing cost or duration overruns. In various embodiments, the decision-support system identifies a contingency plan that is most likely to balance risks and rewards as a recommended contingency plan.

At operation 338, the decision-support system selects a contingency plan incorporating the candidate resources and their capabilities and states or state estimations when simulated forward. In various embodiments, the selection is made automatically based on the contingency plan that is identified as the recommended contingency plan. In various embodiments, a user interface is presented to various stakeholders for use in determining a course of action in real time. In various embodiments, input from the stakeholders determines the course of action for the outage. Options may include staying the course (e.g., staying with the current plan despite a probability of a cost or duration overrun), taking a hit (e.g., incurring additional costs associated with resources for implementing the plan, such as labor, parts, or space resources), or deferring one or more tasks of the plan (e.g., moving a candidate-do task from the plan for the current outage to a subsequent outage). In various embodiments, the decision-support system presents a real-time analysis of the impact of each of the possible courses of action on various metrics associated with the industrial system, including metrics identified above. The analysis may be presented as one or more visualizations, such as charts, graphs, and so on, as described in more detail below.

Results of the implementation of a plan during an actual outage, including unforeseen circumstances encountered, contingency plans chosen, cost overruns, duration overruns, and other data items describing any discrepancy between a plan and its actual implementation, including discrepancies in any task attributes, are stored for later access and aggregation with other data items collected from multiple other actual outages and multiple other industrial systems. A probabilistic analysis is then presented to stakeholders in visualizations to aid in the decision-making process of a new outage plan, including selecting candidate-do tasks, making early decisions for pruning potential trouble paths, mitigate risks based on unforeseen circumstances, and selecting optimal contingency plans.

Data collected in real time during an actual outage used to make predictions of violations of personal limits rules (e.g., as defined by government regulatory agencies or stakeholders) for each worker in the work force assigned to the outage in a probabilistic manner. The predictions are then communicated in real time to stakeholders, such that they are aided in decisions during the outage with respect to allocations of workers to particular tasks, changes to the size of the work force, changes to crew shifts, changes to assignments of particular workers to particular locations, and so on.

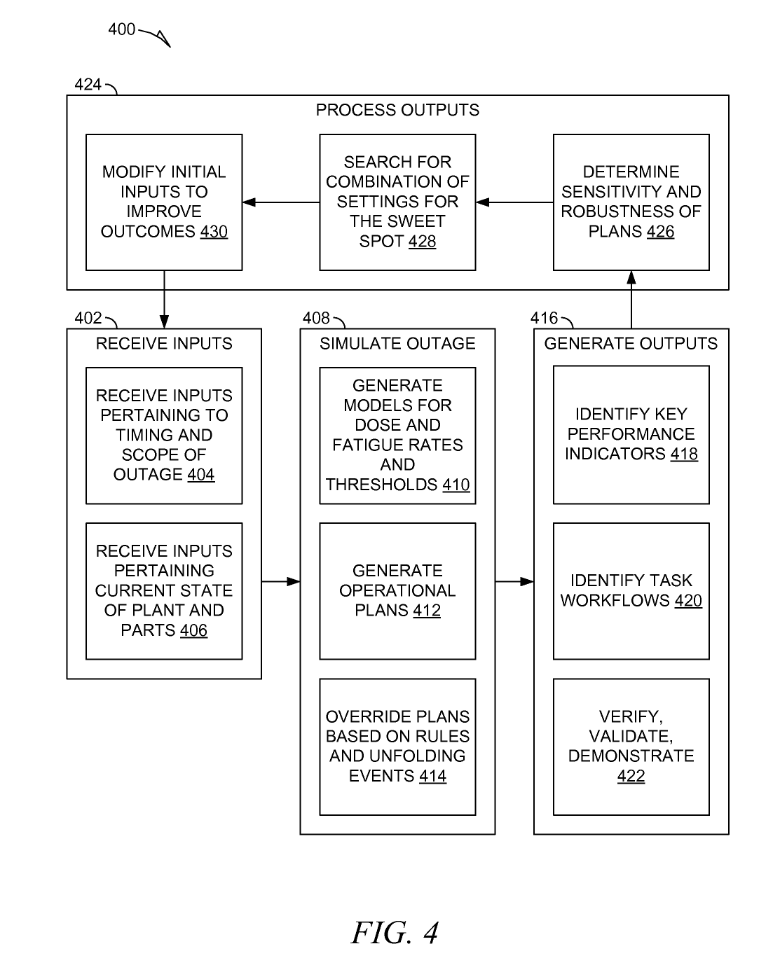

FIG. 4 is a flowchart illustrating example operations of a method 400 for optimizing a plan for managing an outage at an industrial system. In various embodiments, the operations may be performed by one or more modules of the server application(s) 120.

At 402, inputs pertaining to the outage are received. Such inputs may include, for example, at 404, receiving a timing and scope of the outage and, at 406, receiving a current state of the plant and parts of the industrial facility. In various embodiments, the timing of the outage includes a start date and an end date for the outage or a duration of the outage. Additionally, the scope may include one or more tasks that are planned for completion during the outage and information pertaining to the work force that is to be assigned to each of the one or more tasks.

At 408, the outage is simulated based on the inputs. The simulating includes, at 410, generating models for dose and fatigue rates 410 for each of the workers in the work force or net radiation such as for the plant at large, for example in decomissioning. The models may be based on the type of task to which each worker is assigned the location within the industrial facility where the workers will complete the tasks, and personal limit rules pertaining to safety or other metrics, including fatigue levels and radiation does, including exposure or absorption. At 412, an operational plan is generated based on the tasks that are identified for inclusion in the scope of the outage. For example, tasks that have antecedent or predecessor relationships are identified, tasks that can be performed concurrently are identified, and tasks are scheduled based on worker capacity (including dose or fatigue capacity) and availability. Additionally, tasks may be prioritized based on importance levels, including whether tasks are must-do tasks or candidate-do tasks. Certain tasks can be, for example, fuel placements through time that are optimally placed to achieve lifecycle economic and/or radiation states at specified points in future time. In various embodiments, must-do tasks may include tasks that must be completed during the outage (e.g., based on regulatory requirements). In other embodiments, must-do tasks may include tasks that must be completed for the industrial system to achieve one or more performance metrics after the outage (e.g., establish a certain net present value for the industrial system, achieve a certain financial result, such as a gross profit margin, achieve a certain performance level, such as a certain electricity output, and so on). Optional tasks may be additional tasks that should be completed during the outage to, for example, reduce a scope of a subsequent outage, increase a performance level of the industrial system after the outage, and so on. In various embodiments, a critical path for the outage is identified based on the generated operational plans.

At 414, unforeseen circumstances are randomly generated. In various embodiments, such unforeseen circumstances may include unexpected radiation exposure of one or more workers assigned to the tasks, unexpected condition of the plant or parts, unexpected inability of workers to complete tasks in the expected time frame, and so on. In various embodiments, based on a probability transgressing a predetermined value that a budget or duration of the outage will be exceeded, the plan for the outage may be dynamically adjusted. For example, one or more tasks may be removed from the plan to bring the project back within budget or time constraints, or not, based on a risk-return analysis. The tasks that are to be removed from the scope of the outage may be identified based on a risk-return analysis, including an analysis of the impact of the removal of the task on one or more performance metrics.

At 416, outputs pertaining to the simulation are generated. For example, at 418, key performance indicators are identified. For example, indicators having the most significance with regard to keeping the project on track are identified, such as number of workers of each type in the work force, locations of tasks that are to be completed, fatigue or radiation risks associated with each task, a number or type of dependencies of tasks upon one another, and so on. At 420, task workflows are identified, including most efficient ordering of tasks, including concurrent or dependent tasks. At 422, the outputs are verified, validated, and demonstrated. For example, a user interface is generated that includes visualizations (e.g., graphs, charts, spreadsheets, and so on) of comparisons of different task workflows and performance indicators.

At operation 424, the outputs of the simulation are processed. For example, at 426, a sensitivity and robustness of the operational plans is determined. At operation 428, what-if scenarios are used to search for a combination of settings (e.g., inputs) that would have improved the outcome of the simulation (e.g., improved the chances of the project being completed on time or on budget, improved a subsequent performance metric of the industrial facility, reduced costs, reduced average fatigue or dosage levels per worker, and so on). It can be appreciated that the sequence of tasks to achieve a desired physical state subject to financial constraints can span several outage and operations periods and into the decommissioning sequence. At 430, the initial inputs (e.g., the inputs received at 402) are modified based on the identified sweet spot settings. The modified inputs are then fed back into the method 400. Additional simulations are run until an optimal plan is identified, including an optimal scope of the outage, prioritization of tasks within the operational plan, and so on.

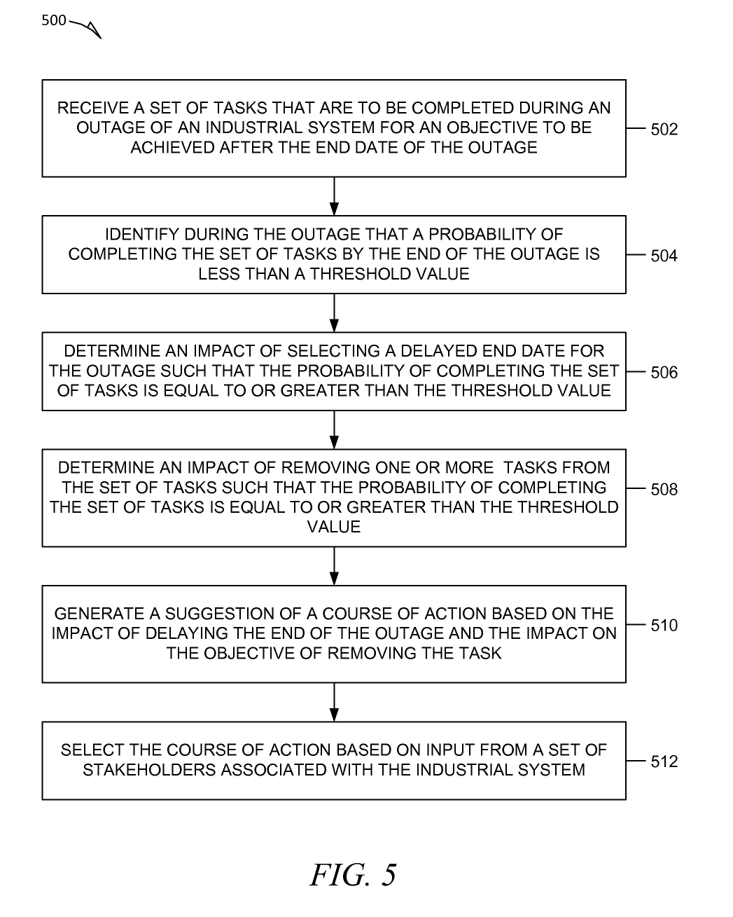

FIG. 5 is a flowchart illustrating example operations of a method 500 for selecting an optimal course of action to improve the chances that a project will be completed on time or on budget or to mitigate the consequences of a time or budget overrun. In various embodiments, the operations may be performed by one or more modules of the server application(s) 120.

At operation 502, a set of tasks that are to be completed during an outage of industrial system are received. In various embodiments, the set of tasks include must-do tasks. Some of these must-do tasks may be tasks that are required for the industrial system to comply with regulatory standards, such as those set by a governmental agency. In various embodiments, the must-do tasks include tasks that are required for the industrial system to meet one or more objectives established by stakeholders associated with the industrial system, such as a performance, efficiency, operating, financial, customer satisfaction, or other objectives. In various embodiments, the set of tasks may include optional (candidate-do) tasks. These candidate-do tasks may be selected based on various criteria, such as their impact on reducing the scope of subsequent planned outages and their ability to be performed concurrently with other tasks of the project or within the time and budget constraints of the project for the outage. It can be appreciated that a sequence can span multiple outages.

At operation 504, it is identified during the outage that probability of completing the set of tasks during the outage has fallen below a threshold value. For example, consider a requirement (e.g., set forth by the stakeholders) that, during the execution of the project, the project is to maintain at least a 90% chance of being completed on time and on budget. At operation 504, it may be identified at some point during the execution of the project (e.g., based on unforeseen circumstances) that the chances of the project have fallen below 90%.

At operation 506, an impact of selecting a delayed end date for the outage such that the probability of completing the set of tasks is equal to or greater than the threshold value is determined. For example, the critical path of the project may be analyzed to determine an amount of slippage that would be required to ensure with the required threshold probability that all of the set of tasks will be completed. The amount of slippage could then be used as an input for determining an impact on any of the performance metrics by which a success of the project will be measured by the stakeholders.

At operation 508, an impact of removing one or more tasks from the set of tasks such that the probability of completing the set of tasks is equal to or greater than the threshold value is determined. For example, the impact of removing a task may be assessed in terms of its impact on the cost or duration of the project. Or the impact may be assessed based on an effect on the net present value, efficiency, performance, operation costs, capital expenditures, financial statements, and so on, associated with the industrial facility after the completion of the outage.

At operation 510, a suggestion of a course of action is generated. The suggestion may be based on an analysis of the risks and returns associated with each course of action. Various stakeholders may be presented with information pertaining to the risks and returns in a user interface in real time during the outage. The information may include comparisons of the effects of selecting each of the identified courses of action to aid the stakeholders in making a determination of which course of action to pursue in real time.

At operation 512, a course of action may be selected. In various embodiments, the selected course of action is based on input from stakeholders. In various embodiments, the selection may be performed automatically based on the suggested course of action. Which selections are performed automatically and which require stakeholder input may be predetermined by the stakeholders. Additionally, levels of approvals for various actions may be defined by the stakeholders, such that particular courses of action may be selected or approved by various individuals, such as field managers, supervisors, vice presidents, executives, or a chief executive officer.

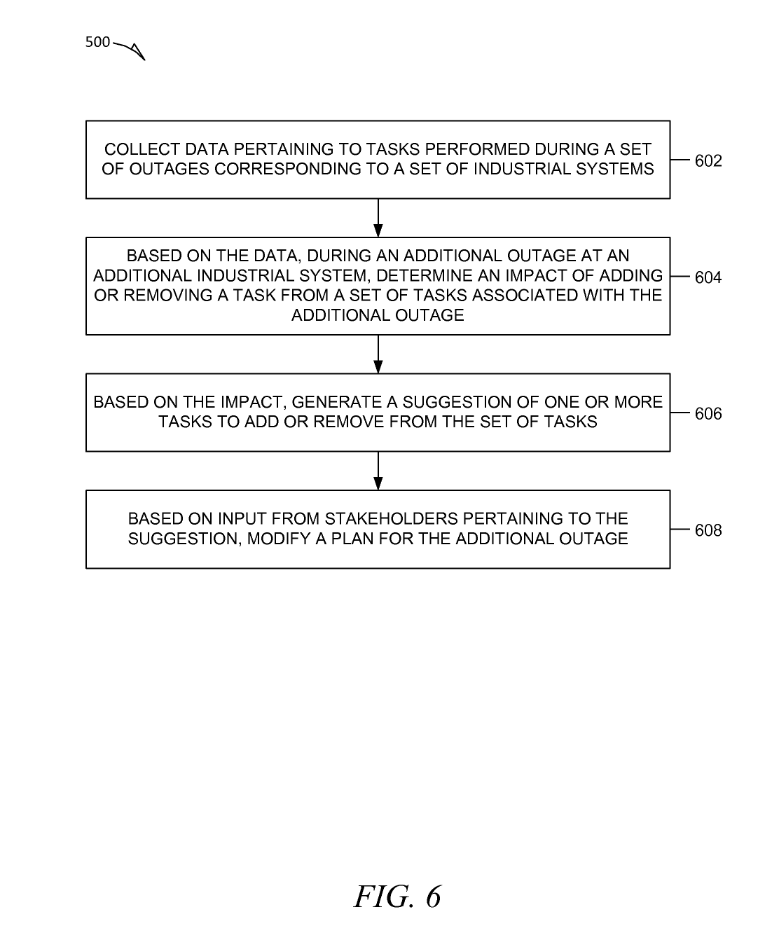

FIG. 6 is a flowchart illustrating example operations of a method 600 for modifying a plan for an outage in real time based on collective intelligence gathered from previous outages. In various embodiments, the method 600 may be performed or more modules of the server application(s) 120. It can be appreciated that an economic lifecycle can be controlled by the disclosed system when a number of outages, operations and decommissioning events are linked in temporal sequence.

At operation 602, data pertaining to tasks performed during a set of outages corresponding to a set of industrial systems is collected. The data may include information pertaining to deviations from a planned project associated with each of the previous outages, including impacts associated with the deviations on any of the performance metrics pertaining to a subsequent outage. The data may also include information pertaining to implementation of actual tasks observed during each of the previous outages, including the actual durations of the tasks and the costs of the tasks, including costs associated with labor, parts, and so on that were required to complete each of the tasks. Additionally, the data may include information pertaining to relationships identified between each task and other tasks, such as predecessor and antecedent relationships. Additionally, the data may include information pertaining to regulatory requirements, such as worker rules pertaining to fatigue and radiation exposure/absorption.

At operation 604, during an actual outage at an additional industrial system, the impact of adding or removing a task from a set of tasks associated with the additional outage is determined. The impact may be assessed based on an aggregation of the data collected at operation 602. For example, the impact may be assessed in terms of a probabilistic model in which each of the collected data items is a single point. The distribution of the data points within the model may be used to determine an impact of the task change on the project with a calculated probability based on the data points.

At operation 606, based on the impact, a suggestion of one or more tasks to add or remove from the set of tasks may be generated. For example, if tasks scheduled for a scope of a plan for a subsequent outage may be added to the scope of a plan for a current outage without jeopardizing a probability that the current plan will stay on time and on budget, those tasks may be selected as recommendations for including in the current plan. If, on the other hand, tasks scheduled for a scope of the current plan have caused the probability that the current plan will stay on time and on budget to fall below a threshold, a suggestion of one or more tasks to remove from the scope of the current plan may be generated.

At operation 608, as discussed above with respect to FIG. 5, based on input from one or more stakeholders, the plan for the current outage may be modified (e.g., in real time) to incorporate one or more of the suggestions. Or, in various embodiments, a selection may be made automatically.

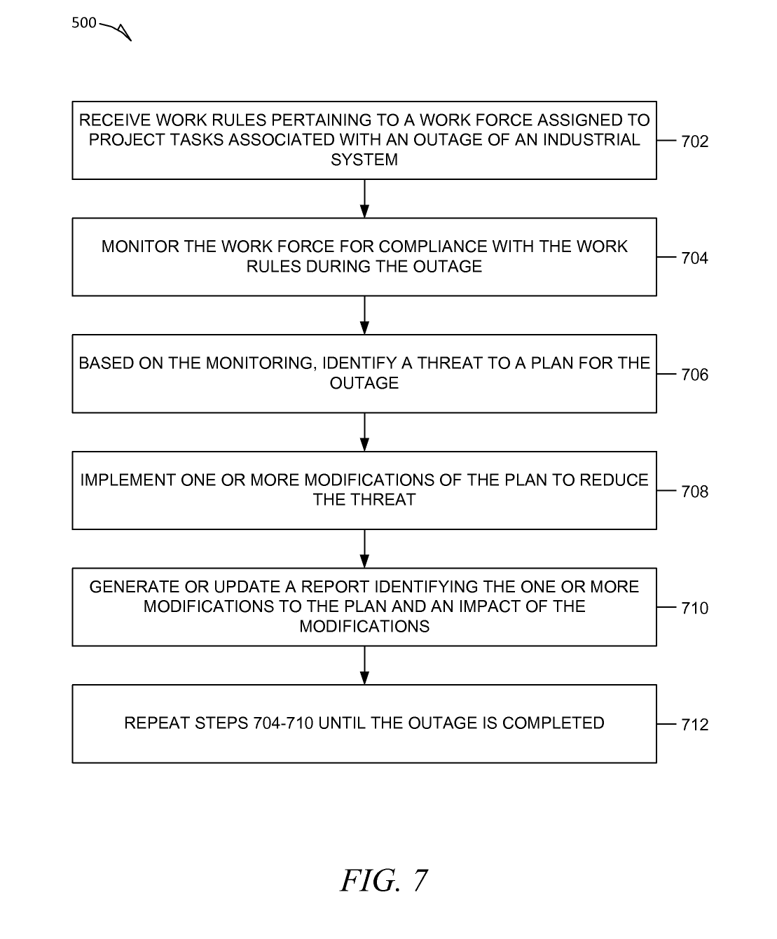

FIG. 7 is a flowchart illustrating example operations of a method 700 for generating a real-time dynamic report identifying the impact of modifications to an outage plan on various success metrics. In various embodiments, the method 700 may be performed or more modules of the server application(s) 120.

At operation 702, work rules pertaining to a work force assigned to project tasks associated with an outage of an industrial system are received. For example, rules pertaining to fatigue and radiation exposure levels are received.

At operation 704, the work force is monitored for compliance with the work rules. For example, in various embodiments, data pertaining to the work rules is collected from one or more devices of each of the workers, such as a Rembit, Fitbit, radiation detector, mobile phone, GPS device, and so on, is collected in real time.

At operation 706, based on the monitoring, a threat to a plan for the outage is identified. For example, it may be determined that, based on unforeseen worker fatigue levels or unforeseen worker radiation exposure, the chances of the project being completed on time and on budget have fallen below a threshold value.

At operation 708, one or more modifications are implemented to reduce the threat. For example, the size of the work force is increased above an initial size, a crew of a work force is changed out earlier than planned, or one or more tasks are removed from the plan, as described above with respect to FIGS. 4-6.

At operation 710, a dynamic report is generated or updated in real time to identify the one or more modifications to the plan and the impact of the modifications on one or more of the success metrics for the plan. Thus, each of the stakeholders associated with the project may have access to data pertaining to deviations from the plan and the impact of those deviations to aid in their decision-making Additionally, external parties, such as government regulatory agencies, may be provided with up-to-date information pertaining to the costs associated with the compliance of the project with safety or other standards.

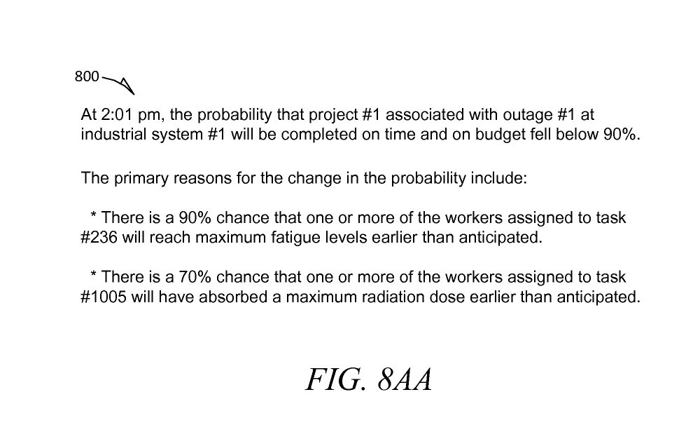

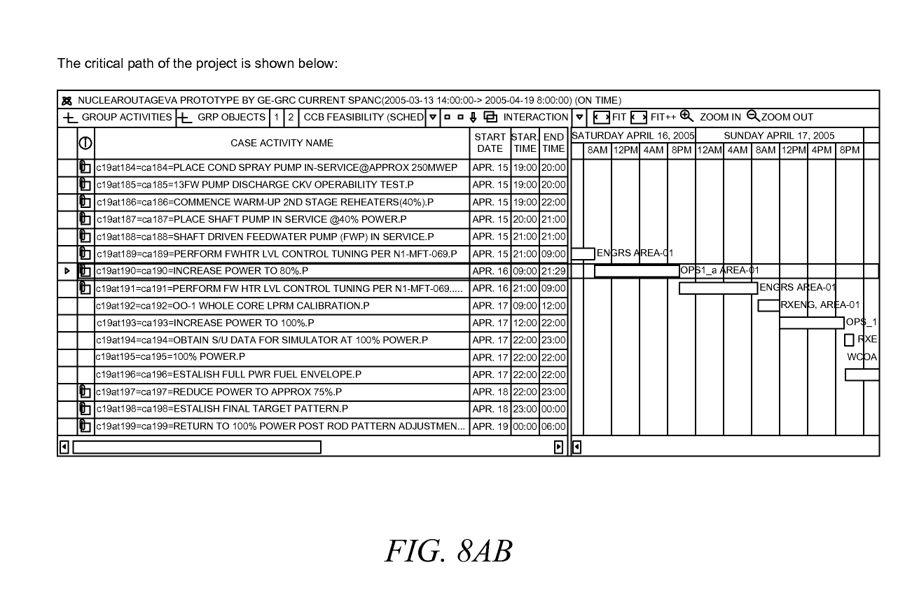

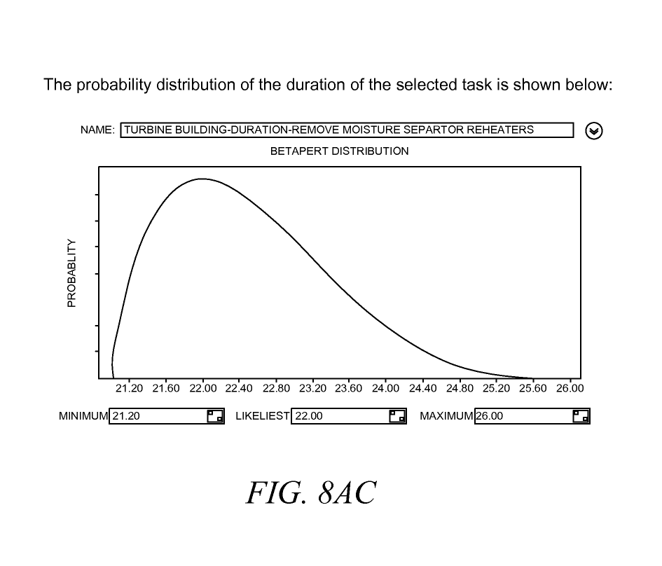

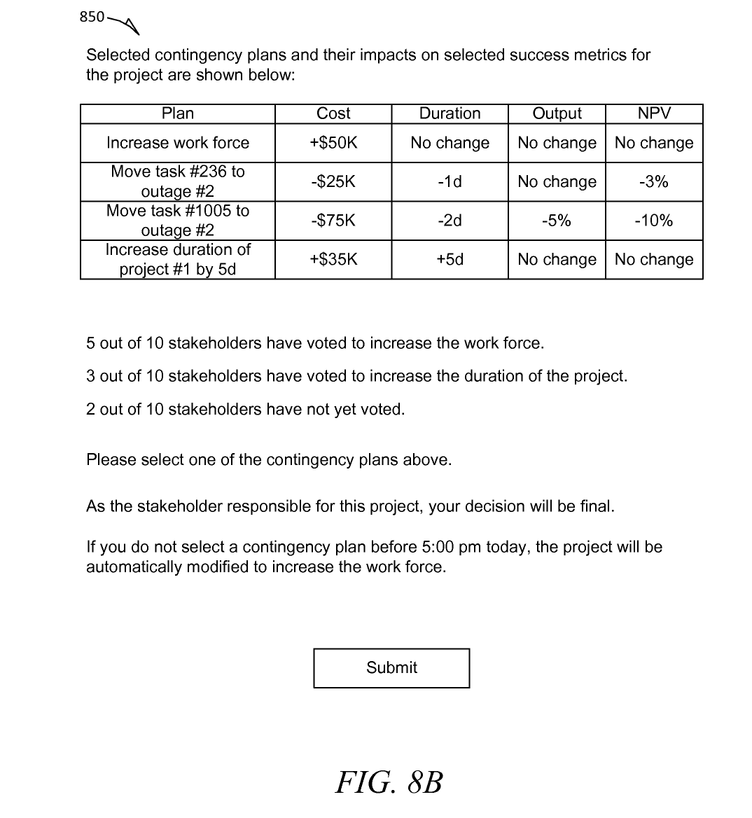

FIGS. 8AA-8AC are a first portion 800 of an example user interface for aiding a stakeholder in making a decision during an actual outage with regard to a modification to a plan for the outage.

The user interface includes a notification to the stakeholder that a probability that the plan will be completed on time and on budget has fallen below a threshold value (e.g., 90%). Additionally, the user interface includes an identification of the primary reasons for the change in the probability, such as the chances that workers will exceed their maximum fatigue or dosage levels before completing a task. The user interface includes information pertaining to the critical path of the project, including information pertaining to the likely duration of each of the tasks in the critical path. In various embodiments, the stakeholder may select a task to view the probability distribution of the task.

FIG. 8B is a second portion 850 of the example user interface for aiding the stakeholder in making the decision during an actual outage with regard to a modification to a plan for the outage.

The user interface includes a selected list of contingency plans and provides what-if scenarios regarding the impacts of each of the contingency plans on selected success metrics pertaining to the project. As described above, the success metrics may include an assessment of impacts on the cost and duration of the project as well as an assessment of impacts on the industrial system after the outage is completed, such as a change in output, net present value, financial statements, and so on associated with the contingency plan.

The user interface may include information pertaining to the wishes of the stakeholders associated with the project regarding the contingency plans, such as the number of stakeholders that have voted for each contingency plan.

For the stakeholder that is ultimately responsible for selecting the contingency plan, various options may be provided for selecting one of the contingency plans or allowing a default or recommended change to the plan to automatically occur when a deadline relevant to the selection is reached.

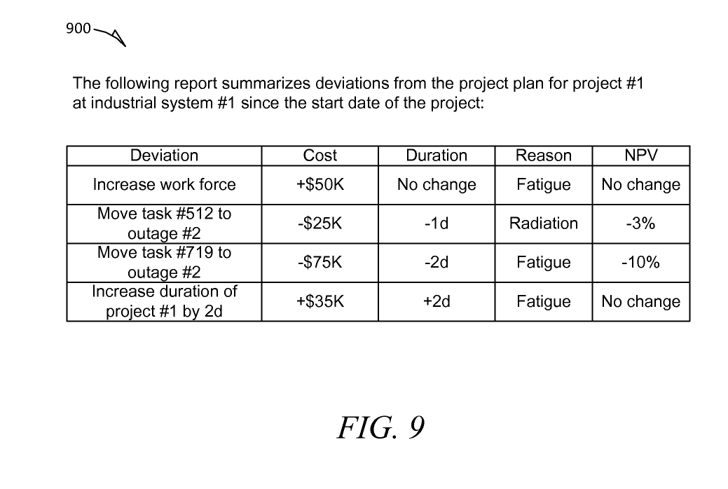

FIG. 9 is an example user interface 900 of a dynamic report that is generated and updated during the execution of a project plan. The dynamic report includes information pertaining to deviations of the plan that have occurred since the implementation of the plan commenced. The information pertaining to the deviations may include information pertaining to impact of the deviation on the cost or duration of the project. Additionally, the information may include the reasons for the deviations and the impact of the deviations on success metrics associated with the operation of the industrial facility after the completion of the project, as described above.

Thus, in various embodiments, probabilistic models are generated in real-time for an industrial system outage from data items generated and stored during multiple previous industrial system outages. The probabilistic models may treat each received data item as a data points in the models. The models may relate to probabilities that an unforeseen circumstance will arise, such as unacceptable radiation exposure or fatigue levels, probabilities that particular tasks will be completed within a particular time frame, probabilities that selections of a particular contingency plans will have particular effect on particular success metrics related to the outage, probabilities that a project plan, taken as a whole, will be completed within a particular time frame or budget, and so on, as described above. The models may then be used to simulate what-if scenarios for the current outage to aid stakeholders responsible for managing the outage in their decision-making in real time. A set of the best possible courses of action, based on simulations using the probabilistic models in conjunction with success metrics and thresholds specified by the stakeholders, may be recommended in real time to appropriate stakeholders within a chain of project responsibilities. Contingency plans may be selected based on input from the stakeholders, a default selection by the decision-support system, or a combination of such inputs. The points at which decisions must be made or finalized may be identified based on probabilities of project slippage and or cost overruns exceeding one or more threshold values. Data items pertaining to the implementation of the plan for the current outage are then fed back into the system for incorporation into models generated for aiding decision making during future outages.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

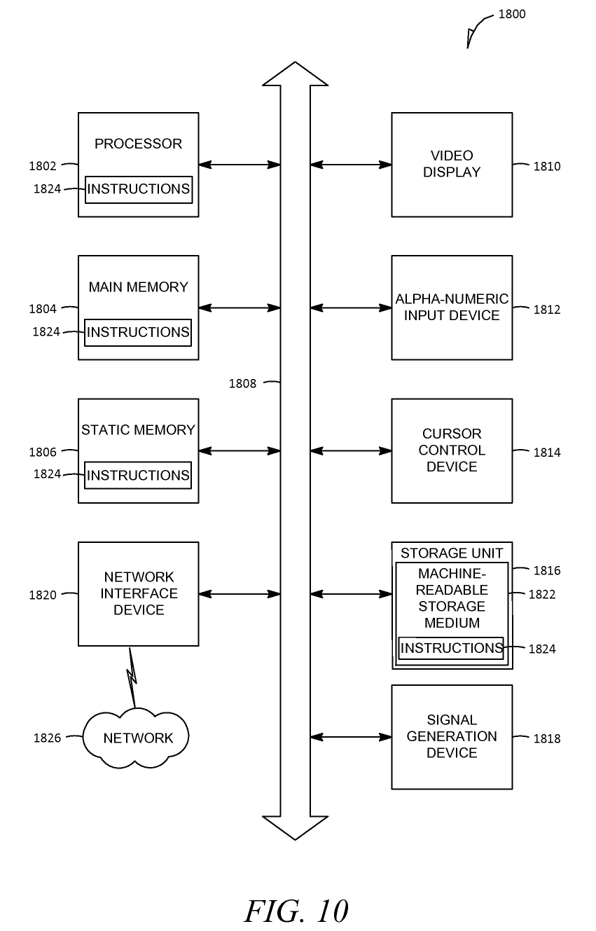

FIG. 10 is a block diagram of machine in the example form of a computer system 1800 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1800 includes a processor 1802 (e.g., a central processing unit (CPU), a graphics processing unit (GPU) or both), a main memory 1804 and a static memory 1806, which communicate with each other via a bus 1808. The computer system 1800 may further include a video display unit 1810 (e.g., a liquid crystal display (LCD) or a cathode ray tube (CRT)). The computer system 1800 also includes an alphanumeric input device 1812 (e.g., a keyboard), a user interface (UI) navigation (or cursor control) device 1814 (e.g., a mouse), a storage unit 1816, a signal generation device 1818 (e.g., a speaker) and a network interface device 1820.

The storage unit 1816 includes a machine-readable medium 1822 on which is stored one or more sets of data structures and instructions 1824 (e.g., software) embodying or utilized by any one or more of the methodologies or functions described herein. The instructions 1824 may also reside, completely or at least partially, within the main memory 1804 and/or within the processor 1802 during execution thereof by the computer system 1800, the main memory 1804 and the processor 1802 also constituting machine-readable media. The instructions 1824 may also reside, completely or at least partially, within the static memory 1806.

While the machine-readable medium 1822 is shown in an example embodiment to be a single medium, the term “machine-readable medium” may include a single medium or multiple media (e.g., a centralized or distributed database, and/or associated caches and servers) that store the one or more instructions 1824 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

Accordingly, a “tangible machine-readable medium” may refer to a single storage apparatus or device, as well as “cloud-based” storage systems or storage networks that include multiple storage apparatus or devices. Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 1824 may further be transmitted or received over a communications network 1826 using a transmission medium. The instructions 1824 may be transmitted using the network interface device 1820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding or carrying instructions for execution by the machine, and includes digital or analog communications signals or other intangible media to facilitate communication of such software. The network 1826 may be one of the networks 104.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method to dynamically and automatically control physical and financial states of one or more of outage workscope, tasks, and resource assignment through time, the method comprising:
accessing data items in a database pertaining to changes to past plans associated with past outages of a plurality of industrial systems, the data items including measurements of impacts of the changes to the past plans;
accessing physical state estimations of apparatuses pertaining to objects that maintenance work scope and operations are influenced by;
accessing work rules data in the database pertaining to a work force, the work force responsible for implementing an additional plan, the additional plan corresponding to an additional outage of an additional industrial system, the work rules data including exposure thresholds for workers in the work force;
based on a determination, using one or more hardware processors, during the outage of a probability that one or more of the exposure thresholds or desired physical states will be exceeded, generating a recommendation for a change to the additional plan, the recommendation based on assumptions derived from first principles models or measurements of the impacts of the changes to the past plans; and
modifying, using the one or more processors, the additional plan based on an acceptance of the recommendation by a plurality of stakeholders associated with the additional plan.

2. The method of claim 1, further comprising generating a report during the outage, the report including information pertaining to the modifying of the additional plan, the information showing a cost incurred as a consequence of the acceptance of the recommendation.

3. The method of claim 1, wherein the recommendation is selected from a delaying of the end date of the outage, a removing of a task from the plan, and a modifying the work force.

4. The method of claim 3, wherein the selecting is based on a comparison of a decrease in an anticipated performance level of the industrial facility based on the removing of the task, a cost of the delaying of the end date of the outage, and a cost of the modifying of the work force.

5. The method of claim 4, further comprising using simulations based on the data items to generate probabilities associated with the decrease in the anticipated performance level, the cost of the delaying of the end date of the outage, and the cost of the modifying of the work force.

6. The method of claim 1, wherein the work rules further include radiation exposure thresholds and further comprising generating the recommendation for the change to the additional plan based on a determination during the outage of a probability that one or more of the radiation exposure thresholds will be exceeded.

7. The method of claim 6, wherein the probability that the one or more of the fatigue thresholds will be exceeded and the probability that the one or more of the radiation exposure thresholds will be exceeded is based on simulations of the outage, the simulations based on the data items.

8. A system comprising:
one or more modules implemented by one or more processors, the one or more modules configured to:
receive data items pertaining to changes to past plans associated with past outages of a plurality of industrial systems, the data items including measurements of impacts of the changes to the past plans;
host and receive physics based estimations of radioactivity from a simulation of the reactor;
receive work rules pertaining to a work force, the work force responsible for implementing an additional plan, the additional plan corresponding to an additional outage of an additional industrial system, the work rules including fatigue and radioactivity thresholds for workers in the work force;
based on a determination during the outage of a probability that one or more radiation or fatigue thresholds will be exceeded, generate a recommendation for a change to the additional plan, the recommendation based on the measurements of the impacts of the changes to the past plans or hypothetical future plans as implemented in a simulated reactor; and
modify the additional plan based on an acceptance of the recommendation by a plurality of stakeholders associated with the additional plan

9. The system of claim 8, further comprising generating a report during the outage, the report including information pertaining to the modifying of the additional plan, the information showing a cost incurred as a consequence of the acceptance of the recommendation.

10. The system of claim 8, wherein the recommendation is selected from a delaying of the end date of the outage, a removing of a task from the plan, and a modifying the work force.

11. The system of claim 10, wherein the selecting is based on a comparison of a decrease in an anticipated performance level of the industrial facility based on the removing of the task, a cost of the delaying of the end date of the outage, and a cost of the modifying of the work force.

12. The system of claim 11, further comprising using simulations based on the data items to generate probabilities associated with the decrease in the anticipated performance level, the cost of the delaying of the end date of the outage, and the cost of the modifying of the work force.

13. The system of claim 8, wherein the work rules further include radiation exposure thresholds and further comprising generating the recommendation for the change to the additional plan based on a determination during the outage of a probability that one or more of the radiation exposure thresholds will be exceeded.

14. The system of claim 13, wherein the probability that the one or more of the fatigue thresholds will be exceeded and the probability that the one or more of the radiation exposure thresholds will be exceeded is based on simulations of the outage, the simulations based on the data items.

15. A non-transitory machine readable medium comprising a set of instructions that, when executed by a processor, causes the processor to perform operations, the operations comprising:
receiving data items pertaining to changes to past plans associated with past outages of a plurality of industrial systems, the data items including measurements of impacts of the changes to the past plans;
receiving work rules pertaining to a work force, the work force responsible for implementing an additional plan, the additional plan corresponding to an additional outage of an additional industrial system, the work rules including fatigue thresholds for workers in the work force;
based on a determination during the outage of a probability that one or more fatigue thresholds will be exceeded, generating a recommendation for a change to the additional plan, the recommendation based on the measurements of the impacts of the changes to the past plans; and
modifying the additional plan based on an acceptance of the recommendation by a plurality of stakeholders associated with the additional plan, one or more modules incorporated into a networked system to perform the receiving of the data items, the receiving of the work rules, the generating of the recommendation, and the modifying of the additional plan, the one or more modules implemented by one or more processors of the networked system.

16. The non-transitory machine readable medium of claim 15, the operations further comprising generating a report during the outage, the report including information pertaining to the modifying of the additional plan, the information showing a cost incurred as a consequence of the acceptance of the recommendation.

17. The non-transitory machine readable medium of claim 15, wherein the recommendation is selected from a delaying of the end date of the outage, a removing of a task from the plan, and a modifying the work force.

18. The non-transitory machine readable medium of claim 17, wherein the selecting is based on a comparison of a decrease in an anticipated performance level of the industrial facility based on the removing of the task, a cost of the delaying of the end date of the outage, and a cost of the modifying of the work force.

19. The non-transitory machine readable medium of claim 18, further comprising using simulations based on the data items to generate probabilities associated with the decrease in the anticipated performance level, the cost of the delaying of the end date of the outage, and the cost of the modifying of the work force.

20. The non-transitory machine readable medium of claim 15, wherein the work rules further include radiation exposure thresholds and further comprising generating the recommendation for the change to the additional plan based on a determination during the outage of a probability that one or more of the radiation exposure thresholds will be exceeded.
